(19) United States
(12) Patent Application Publication
(10) Pub. No.: US 2026/0237707 A1
(43) Pub. Date: Aug. 13, 2026

(54) RECHARGEABLE LIQUID FUEL CELL SYSTEM AND METHOD

(71) Applicant: FLOW CELL TECH, LLC, Noank, CT (US)

(72) Inventor: Michael L. Perry, Noank, CT (US)

(21) Appl. No.: 19/391,331

(22) Filed: Nov. 17, 2025

Related U.S. Application Data
(63) Continuation-in-part of application No. 17/573,612, filed on Jan. 11, 2022, now Pat. No. 12,476,269.
(60) Provisional application No. 63/135,921, filed on Jan. 11, 2021.

(51) Int. Cl. H01M 8/18

(52) U.S. Cl. CPC H01M 8/184

(57) ABSTRACT

A rechargeable liquid fuel cell includes a negative liquid electrode, a positive gas electrode, an electrolyte separator disposed between the negative liquid electrode and the positive gas electrode, and an electrical circuit connected to the positive and negative electrodes. The negative liquid electrode includes an electrochemically-reversible liquid fuel comprising a formate salt and a bicarbonate salt. The positive gas electrode includes an oxygen-containing gas. The electrolyte separator includes a first side having a negative catalyst layer formulated to promote, during fuel cell discharge, the electrochemical oxidation of formate ions to bicarbonate ions. The electrolyte separator further includes a second opposing side having a positive catalyst layer formulated to promote, during fuel cell discharge, an electrochemical oxygen reduction reaction.

### RELATED APPLICATIONS

This application is a continuation-in-part of U.S. patent application Ser. No. 17/573,612, filed Jan. 11, 2022, currently pending, which claims the benefit of U.S. Provisional Application No. 63/135,921, filed Jan. 11, 2021, each of which is incorporated by reference herein in its entirety.

### BACKGROUND OF THE INVENTION

This disclosure relates generally to fuel cells and, more specifically, to a reversible fuel cell that utilizes a novel liquid fuel chemistry.

A rechargeable liquid fuel-cell (RLFC) system can provide an attractive means for transporting and storing energy for a variety of applications, such as electric vehicles (EVs) or grid-scale electrical-energy storage (EES). However, the liquids proposed for RLFCs to date have suffered from relatively poor performance, especially with liquids that have reasonably high energy densities (i.e., on par with conventional Lithium-ion batteries). These performance issues are due to, for example, slow reaction kinetics of the liquid species, challenges associated with the reversibility of the air electrode, and crossover of one or more of the species in the liquid to the air electrode that negatively impacts the air electrode. A summary of the advantages of RLFC systems and a description of various system configurations and potential end-use applications are provided in: M. L. Perry, “Electrochemically-rechargeable Liquids in highly Flexible Energy Storage Systems,” ECS Transactions, 104 (2021).

Previous work on electrochemically-rechargeable liquids has primarily focused on reactants with relatively high energy densities, such as liquid organic hydrogen carriers (LOHCs). However, the electrochemical hydrogenation and dehydrogenation of LOHCs with very high hydrogen content per molecule yield predictably poor cyclability results because of complex reaction mechanisms. Reactants that can undergo electrochemical reactions with relatively small number of electrons per molecule (e.g., ≤2) are inherently simpler and tend to be more reversible and have fewer side reactions. If the concentrations of these reactants in the liquid are sufficiently high, then the energy densities can still be compelling.

Aqueous solutions of formate and bicarbonate salts are attractive since these salts have good solubilities in water, are low cost, readily produced (e.g., from CO₂), and the number of electrons per molecule is two for the conversion between formate and bicarbonate. Formic acid (HCOOH) fuel cells and have been demonstrated, which typically operate at a pH of <4, with the goal being complete oxidation of the fuel to CO₂ and water:

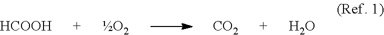

Additionally, formate salt (e.g., KCOOH) fuel cells have also been demonstrated under strongly alkaline conditions (pH>9) since a base is added to the fuel to promote this desired reaction:

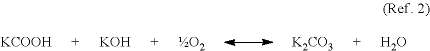

These above fuels are not designed to be reversible, and the inventor is not aware of rechargeable fuel cells using formate and bicarbonate salts, as described herein, being demonstrated.

Redox flow battery (RFB) systems that use carbon dioxide and formic acid or formate salts or bicarbonate salts for the negative redox couple have been taught (Gyenge, U.S. Pat. No. 10,854,906). Improved catalysts for this type of RFB system have also been taught (Yang, U.S. Application 2021/0194031 A1). However, these RFB systems require the storage of CO₂ gas unless the formation of CO₂ is mitigated, which is not taught. Additionally, the storage of second reactant to serve as the positive redox couple (e.g., bromine) is also required in a RFB system. Since the separators in RFB cells are not perfectly selective there will also inevitably be cross contamination of these two different redox couples, which can result in significantly degradation issues. Therefore, RFBs with dissimilar reactants require complicated mitigations in order to maintain the desired performance over multiple cycles, as described in: M. L. Perry, J. D. Saraidaridis, and R. Darling, “Crossover Mitigation Strategies for Redox-Flow Batteries,” Current Opinion in Electrochemistry, 21 (2020). Complications due to crossover are a major reason why the most mature RFB chemistries are those based on symmetric active materials, such as the all-vanadium RFB and the all-iron hybrid RFB systems. The RLFCs taught here only require the storage of one liquid reactant, and the crossover-contamination issues are less problematic since there is only liquid. Therefore, crossover of species from the liquid side will only result in contamination of the gas electrode, not a second reactant reservoir. Crossover mitigation is inherently less problematic with a RLFC than a RFB. Innovative crossover-mitigation strategies are also taught herein, which are much simpler than those used in RFB systems.

### BRIEF SUMMARY OF THE INVENTION

In accordance with one aspect of the disclosure, a rechargeable liquid fuel cell includes a negative liquid electrode, a positive gas electrode, an electrolyte separator disposed between the negative liquid electrode and the positive gas electrode, and an electrical circuit connected to the positive and negative electrodes. The negative liquid electrode includes an electrochemically-reversible liquid fuel comprising a formate salt and a bicarbonate salt. The positive gas electrode includes an oxygen-containing gas. The electrolyte separator includes a first side having a negative catalyst layer formulated to promote, during fuel cell discharge, the electrochemical oxidation of formate ions to bicarbonate ions. The electrolyte separator further includes a second opposing side having a positive catalyst layer formulated to promote, during fuel cell discharge, an electrochemical oxygen reduction reaction (ORR).

In one example, the negative liquid fuel comprises three species in equilibrium: dissolved CO_{2(aq}), bicarbonate ions HCO₃⁻, and carbonate ions CO₃²⁻, and the pH of the liquid fuel is sufficient to favor the bicarbonate ions as a dominant species.

In another example, the positive catalyst layer is further formulated to promote an electrochemical hydrogen-oxidation reaction (HOR) and, during recharging, hydrogen gas is supplied to the positive gas electrode. Electricity is applied to the electrical circuit to promote the electrochemical reduction of bicarbonate ions to formate ions on the negative electrode.

In another example, the positive gas electrode is a reversible electrode, and the positive catalyst layer is further formulated to promote an electrochemical oxygen-evolution reaction (OER). During recharging, water is supplied to the positive electrode and electricity is applied to the electrical circuit to promote the electrochemical reduction of bicarbonate ions to formate ions on the negative electrode.

In accordance with another aspect of the disclosure, a rechargeable liquid fuel cell includes a negative liquid electrode, a positive gas electrode, an electrolyte separator disposed therebetween, and an electrical circuit connected to the positive and negative electrodes. A method of discharging the rechargeable liquid fuel cell includes flowing an oxygen-containing gas through the positive gas electrode to electrochemically reduce the oxygen; flowing an electrochemically-reversible liquid fuel comprising a formate salt and a bicarbonate salt through the negative liquid electrode to electrochemically oxidize formate ions to bicarbonate ions; and generating an electrical current in the electrical circuit.

In accordance with another aspect of the disclosure, a rechargeable liquid fuel cell includes a negative liquid electrode, a positive gas electrode, an electrolyte separator disposed therebetween, and an electrical circuit connected to the positive and negative electrodes. A method of recharging the fuel cell includes applying an electrical current to the electrical circuit; flowing a hydrogen-containing gas through the positive gas electrode to promote an electrochemical hydrogen-oxidation reaction (HOR); and flowing an electrochemically-reversible liquid fuel comprising a formate salt and a bicarbonate salt through the negative liquid electrode to electrochemically reduce bicarbonate ions to formate ions.

In accordance with another aspect of the disclosure, a rechargeable liquid fuel cell includes a negative liquid electrode, a positive gas electrode, an electrolyte separator disposed therebetween, and an electrical circuit connected to the positive and negative electrodes. A method of recharging the fuel cell includes applying an electrical current to the electrical circuit; flowing water through the reversible positive gas electrode to promote an electrochemical oxygen-evolution reaction (OER); and flowing an electrochemically-reversible liquid fuel comprising a formate salt and a bicarbonate salt through the negative liquid electrode to electrochemically reduce bicarbonate ions to formate ions.

In accordance with yet another aspect of the disclosure, a method of removing foreign ions from an ionomer in cells of a rechargeable liquid fuel cell includes detecting a high presence of foreign ions; draining any liquid electrolyte from the fuel cell and replacing it with water having an effective amount of acid or base to promote ion exchange; circulating the water through the cells to exchange foreign ions for desired ions; measuring an ionic conductivity of the circulating water; ceasing circulation when the ionic conductivity decreases below a predetermined value; and draining the water and resuming normal operation of the fuel cell.

In accordance with yet another aspect of the disclosure, a method of removing undesirable precipitates on a liquid electrode in one or more cells of a rechargeable liquid fuel cell includes detecting a presence of unwanted precipitates; flowing a normal reductant on the positive side of the one or more cells; applying a voltage across the one or more cells to cause current flow and the electrochemical reduction of bicarbonates to formates in the liquid electrode; and increasing a flow of liquid electrolyte to dislodge the unwanted precipitates.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 schematically illustrates a rechargeable fuel cell system according to one embodiment of the present invention;

FIG. 2 depicts a plot showing the calculated equilibrium concentrations of the three carbonate species in seawater;

FIG. 3 depicts a plot showing expected energy densities of a rechargeable liquid at expected concentrations;

FIG. 4 depicts a schematic cross sectional exploded view of a generic fuel cell, according to another embodiment of the invention;

FIG. 5 schematically illustrates a rechargeable fuel cell system for charging, according to another embodiment of the invention;

FIG. 6 schematically illustrates a rechargeable fuel cell system for the removal of carbonates on the gas electrode shown in FIG. 4, according to another embodiment of the invention;

FIG. 7 schematically illustrates a rechargeable fuel cell system for removing accumulated foreign ions in the ionomer or ion-exchange membrane shown in FIG. 4, according to another embodiment of the invention;

FIG. 8 depicts a flowchart of a method for removing foreign ions in the ionomer or ion-exchange membrane shown in FIG. 4, according to another embodiment of the invention;

FIG. 9 schematically illustrates a rechargeable fuel cell system for mitigating the H₂ generated on the cathode shown in FIG. 4, according to another embodiment of the invention;

FIG. 10 schematically illustrates a symmetric fuel cell;

FIG. 11 schematically illustrates a rechargeable fuel cell system to preferentially generate and store formate-rich solution using the symmetric cell of FIG. 10, according to one embodiment of the invention; and

FIG. 12 depicts a flowchart of a method for recovering from precipitation on the liquid electrode shown in FIG. 1.

### DETAILED DESCRIPTION OF THE INVENTION

A rechargeable aqueous liquid with formate salts produces the corresponding bicarbonate salts on discharge. These bicarbonate salts may be subsequently charged to the original formate salts. This rechargeable-liquid chemistry is accomplished with a unique fuel cell system and operating strategies that enables the necessary conditions are maintained to ensure the desired reactions. Also disclosed are a number of recovery strategies to mitigate the impact of decay mechanisms in order to maximize the lifetime of the liquid and the fuel-cell system.

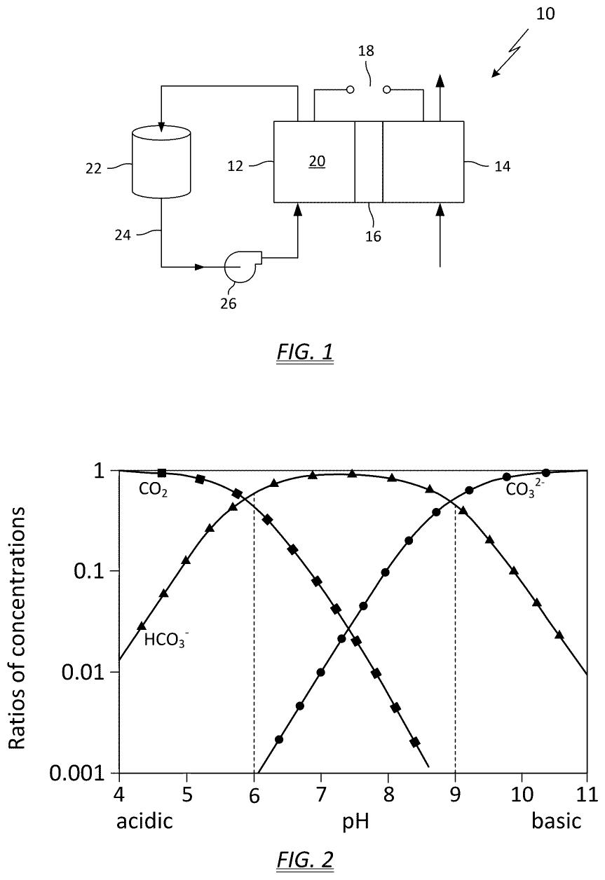

FIG. 1 depicts a rechargeable liquid fuel cell system 10 according to one embodiment of the present invention. The system 10 includes a first electrode 12, a second electrode 14, and an electrolyte separator 16 arranged between the electrodes 12, 14. The electrodes 12, 14 are connected to an electric circuit 18.

The first electrode 12 includes an electrochemically-reversible aqueous liquid fuel 20 comprising a formate salt and a bicarbonate salt. The system 10 further includes at least one vessel 22 fluidly connected in a recirculation loop 24 with the first electrode 12. The vessel 22 can hold the liquid fuel solution 20 for recirculation through the first electrode 12 during operation of the fuel cell system 10. The recirculation loop 24 may also include one or more pumps 26 to facilitate the recirculation of the liquid solution 20 through the loop 24, vessel 22, and first electrode 12.

The second electrode 14 may be a gas electrode, such as an oxygen-containing gas, including air. In one embodiment, the second electrode 14 is a reversible air electrode.

Further description of the first and second electrodes 12, 14 and the electrolyte separator 16 will be provided below.

As noted, the liquid fuel 20 includes an aqueous solution including formate salts and bicarbonate salts. Aqueous solutions with carbonate species consist of three species in equilibrium: dissolved CO_{2(aq)}, bicarbonate ions HCO₃⁻, and carbonate ions CO₃²⁻. The ratios of the three species strongly depend on pH. For example, FIG. 2 depicts a plot showing the calculated equilibrium concentrations of the three carbonate species in seawater. According to the invention, it is desirable for the aqueous solution to have a high concentration of bicarbonate ions, a low concentration of carbonate ions, and minimize, to the extent possible, the concentration of dissolved carbon dioxide. Thus, in one embodiment, the pH range of the aqueous liquid fuel 20 is preferably between about 5 and 10, and most preferably between about 7 and 8. Under these conditions, the bicarbonates concentrations are at least 10 to 20 times higher than the carbonates or CO₂.

Maintaining the pH of the bulk liquid 20 in a range between 5 and 10 may be important to achieving the desired electrochemical reactions. For example, if the fuel 20 becomes too acidic, the bicarbonates will become carbonic acid, which will then decompose to CO₂ and H₂O according to the following exemplary reactions (which should be avoided):

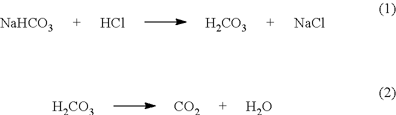

During discharge of the fuel cell 10, i.e., when generating electricity, the formate salts in the liquid electrolyte 20 are electrochemically converted to bicarbonate salts and electrical energy is generated. The desired reactions are dependent upon proper pH range, and straddle the neutral pH of 7; being slightly acidic or basic. Accordingly, the reactions at the positive and negative electrodes will be different depending on the pH being above or below 7.

On the negative electrode, i.e., anode, the desired half-cell reaction for the direct oxidation of formate ions to bicarbonate ions in a slightly basic liquid electrolyte solution 20 (pH≈7 to 10) is

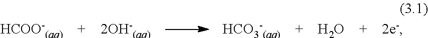

while in a slightly acidic liquid electrolyte solution 20 (pH~5 to 7) the desired half-cell reaction for the direct oxidation is

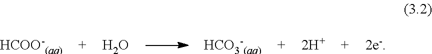

On the positive electrode, i.e., cathode, the desired half-cell reaction for the oxygen-reduction reaction (ORR) for the slightly basic case is

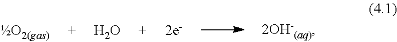

and the desired half-cell reaction for the ORR for the slightly acidic case the is

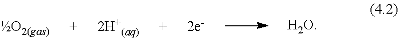

In the acidic case the oxygen is being reduced to water, and in the basic case oxygen is being reduced to hydroxyls (OH groups). The overall cell reaction for each case, slightly acidic or basic, is the same:

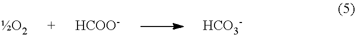

During charging of the fuel cell 10, the bicarbonate salts in the liquid electrolyte 20 are electrochemically converted back to formate salts with electrical energy input at circuit 18. The desired reactions are also dependent upon proper pH range, and straddle the neutral pH of 7; being slightly acidic or basic. Accordingly, the reactions at the positive and negative electrodes will be different depending on the pH being above or below 7.

On the negative electrode, i.e., cathode, the desired half-cell reaction for the direct reduction of bicarbonate ions to formate ions in a slightly basic liquid electrolyte solution 20 (pH≈7 to 10) is the reverse of Equation (3.1):

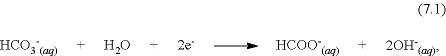

while in a slightly acidic liquid electrolyte solution 20 (pH~5 to 7) the desired half-cell reaction for the direct reduction is the reverse of Equation (3.2):

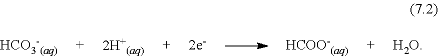

Of note, a significant side reaction that is not desirable, but may occur, is the protons combining with themselves to form hydrogen gas:

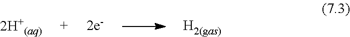

On the positive electrode. i.e., anode, protons are generated or hydroxyls are consumed via reactions that depend upon the reactant and the local pH. In one embodiment, the air electrode 14 is reversible and a desired reaction is an oxygen evolution reaction (OER). For the slightly basic case, the OER half-cell reaction is the reverse of Equation (4.1):

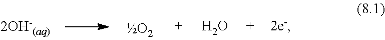

and the desired half-cell reaction for the OER for the slightly acidic case is to split water into oxygen and protons is the reverse of Equation (4.2):

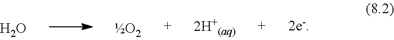

The overall cell reaction for each OER case, slightly acidic or basic, is the reverse of the reactions shown in Eq. (5):

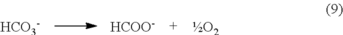

If some H₂O is lost during discharge (e.g., water exits in the air exhaust), it can potentially be made up during the recharging process. The generated water may be fed to the positive electrode 14, retained in the fuel cell system, or it may be exhausted, for example. The exhausted water may be utilized to remove heat for fuel cell thermal balance.

In another embodiment, hydrogen may be supplied to positive electrode 14 (anode) to rehydrogenate the liquid 20 with protons by oxidizing hydrogen instead of splitting water. For the slightly basic case, the hydrogen oxidation (HOR) half-cell reaction is:

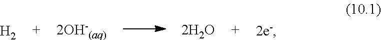

and for the slightly acidic case the HOR half-cell reaction is:

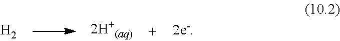

The negative electrode 12 (cathode) half-cell reactions are the same as Eq. 7.1 (basic) and Eq. 7.2 (acidic). The overall cell reaction for each HOR case, slightly acidic or basic, is:

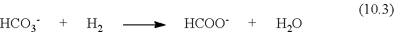

Alternative reaction pathways may also occur, but the net results are the same. On discharge, the indirect oxidation of formate ions to bicarbonate ions may also occur. For example:

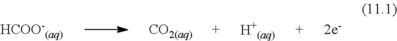

And the equilibrium reaction:

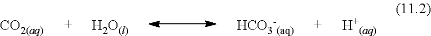

The net of these reactions is the same as Eq. 3.2 above, namely

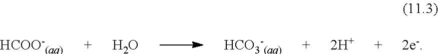

On charge, the indirect reduction of bicarbonate to formate may also occur, but in the opposite direction of Eq. 11.1:

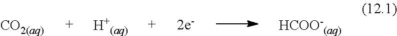

The net of these reactions is the same as Eq. 7.2 above, namely

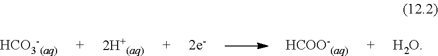

If the catalyst sites in the negative electrode are highly acidic (e.g., due to the use of an ionomer in the electrode with a strong acid, such as a perfluorosulfonic acid ionomer (PFSA)), then the above pathway is likely, since the following reaction is favored at low pH:

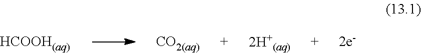

However, if the bulk solution in the negative electrode is in the desired pH range (i.e., near neutral, pH~6 to 9), then the following equilibriums should occur in the bulk of the electrode (i.e., away from the catalyst sites):

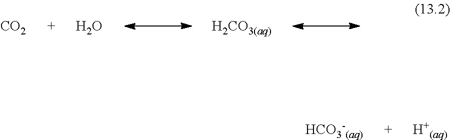

In a liquid with the desired pH range, the bicarbonate ions will dominate (i.e., by more than 10× carbonic acid or CO₂).

Similarly, if the catalyst sites in the negative electrode are highly alkaline (e.g., due to the use of an ionomer in this electrode with a strong base), then the following reaction is favored at high pH:

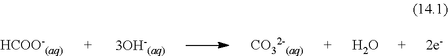

However, if the bulk solution in the negative electrode is in the desired pH range (i.e., near neutral, pH~6 to 9), then the equilibriums of Eq. 13.2 should occur in the bulk of the electrode (i.e., away from the catalyst sites), and the bicarbonate ions will dominate (i.e., by more than 10× carbonate ions).

Table I depicts the thermodynamic open circuit voltage, E⁰, for key reactions, estimated using the Gibbs formation energy, ΔG, for the reactants and products of the overall reactions: E⁰=−nF ΔG. For the discharge reaction, Eq. 5, E⁰ is 1.22 V, which is similar to a hydrogen-air fuel cell. For the charge reaction with hydrogen, Eq. 9, E⁰ is 0.007 V, which illustrates that the formate-bicarbonate salts are energetically an ideal hydrogen storage medium. And, these aqueous liquids are preferable energy carriers compared to gaseous or liquefied hydrogen, since they can be stored in low-cost tanks and are inherently safer than most fuels or the active materials used in conventional batteries.”

TABLE 1

[symbol]

For the dischargeing reaction (and charging reaction with O₂, in the opposite
(direction):

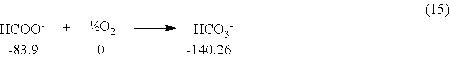

ΔG⁰ ’ −0.56.36 kcal/mol = −235,810 J/mol
E⁰ = −(−235,810 J/mol)/(2*96,487 J/V-mol) = +1.22 V
For the charging reaction with H₂, voltage is ~0 (bicarbonates are ideal for
H2 storage):

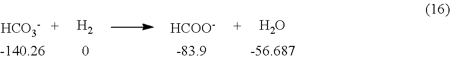

ΔG⁰ = −0.327 kcal/mol = −1,368 J/mol
E⁰ = −(−1,368 J/mol)/(2*96,487 J/V-mol) = +0.007 V ≈ 0
Compare reaction (15) to the reaction that occurs under highly acidic conditions:

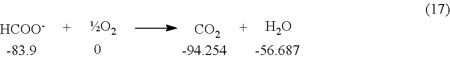

ΔG⁰ = −67.041 kcal/mol = −280,500 J/mol
E⁰ = −(−280,500 J/mol)/(2*96,487 J/V-mol) = +1.45 V
Compare reaction (16) to the reaction that occurs under hightly basic
conditions:

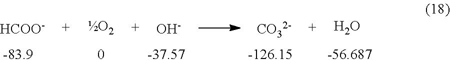

ΔG⁰ = −61.36 kcal/mol = −256,748 J/mol
E⁰ = −(−256,748 J/mol)/(2*96,487 J/V-mol) = +1.33 V [symbol]
indicates data missing or illegible when filed

Regarding the composition of the rechargeable liquid 20, a range of both salt compositions (e.g., choice of cations) and concentrations is possible. The energy density of the liquid 20 depends on the concentration, e.g., how many moles of the formate can be dissolved in water will dictate how much energy is in the liquid. For single-phase operation (i.e., all solids remain dissolved in the aqueous liquid), the desired concentration is about 1M to 5M, since this is the solubility limit of most bicarbonates salts, which have lower solubilities than formate salts.

Higher formate concentrations (about 5M to 20M) may be enabled by utilizing a two-phase (solid/liquid) solution stored inside the vessel 22, in which case the system is not limited by solubility. In this example, the liquid 20 may be supersaturated in both formate and bicarbonate species, or only the bicarbonate species. As the liquid 20 charges and discharges, one of the species is being depleted and the second species is added to. The species being added to will tend to precipitate because it has reached its saturation limit, and the other species that is being depleted, if it is in contact with that solid, will tend to dissolve some of that solid. Thus, the liquid can be replenished by having it in quasi-equilibrium with the solid salts in the vessel 22, which generally are not circulated. Ideally, only the liquid phase is circulated through the cell in this case.

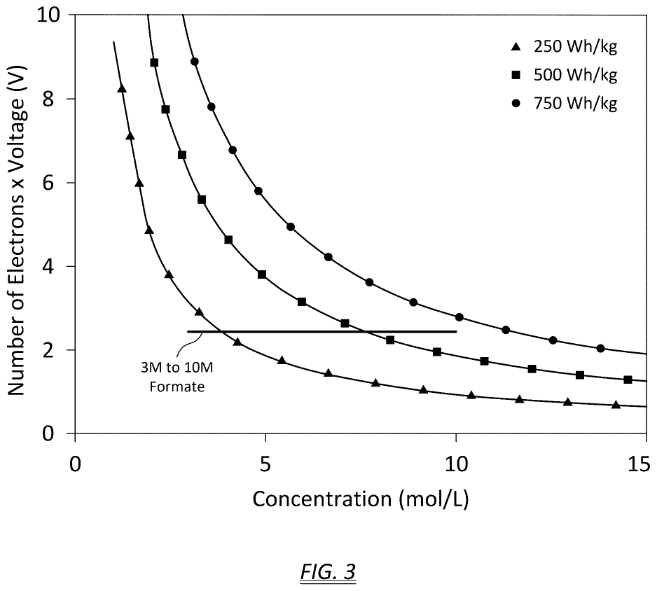

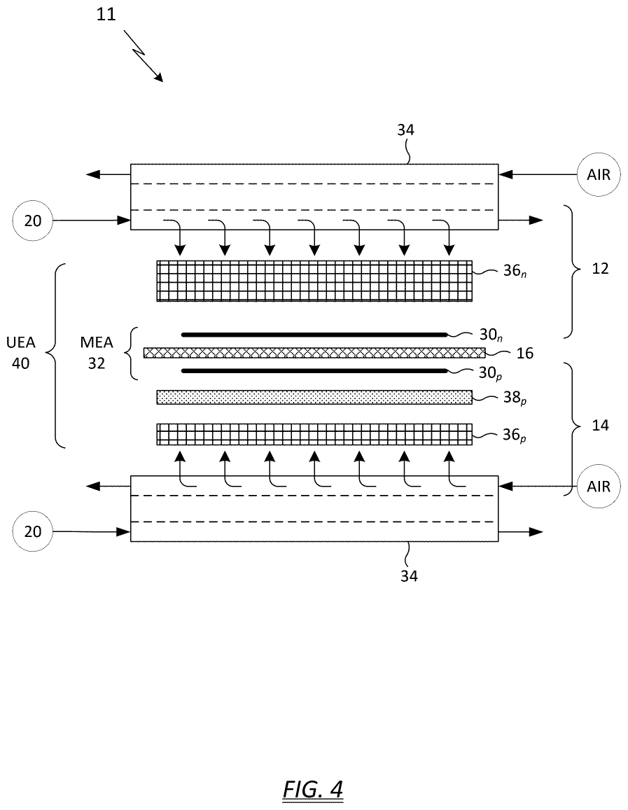

FIG. 3 illustrates expected energy densities of the rechargeable liquid 20 at the concentrations taught above. The y-value of 2.44 V (1.22 V×2 electrons per molecule) is plotted against x-value concentrations of 3 to 10 moles/liter, disclosing that 3M to 10M formate solutions have theoretical energy densities of approximately 250 to 700 Wh/kg. By way of comparison, the energy density of lithium-ion batteries is about 200 Wh/kg. Therefore, the disclosed fuel cell system may have application in vehicles, where the liquid fuel 20 can be swapped out in minutes and the discharged liquid can be recharged offboard the vehicle, if desired. The weight of the fuel cell system also needs to be included here to be compared to conventional batteries, but this comparison should be favorable for long-range vehicles that require energy systems with large energy/power ratios, as long as the power density of the fuel cell stack is reasonable (e.g., on the order of 1 kW/kg).

As noted above, the composition of the rechargeable liquid may also include a range of salt compositions (e.g., choice of cations). The choice of the cation for the formate/bicarbonate salt can impact solubility, and depends on many factors, including the solubility and pH of both salts, the impact on reaction kinetics, the viscosity, and the ionic conductivity of the solution. The concentration of formate used will depend on the solubility of the salts, which depends on cation(s) selected, as well as system design and operational strategy. For single-phase operation (i.e., all solids remain dissolved in the aqueous liquid), the desired concentration is approximately 1M to 5M, and in this use case will most likely be limited by bicarbonate concentration. Higher formate concentrations can be enabled by utilizing two-phase (solid/liquid) delivery and storage concepts. If the system can accommodate precipitation of some salts, high concentrations of formate may be used (e.g., approximately 5M to 20M).

In one example, the cations may be relatively large to mitigate membrane crossover. This may also enhance the solubility of the bicarbonates, as well as reaction kinetics. The cations may be selected from a group comprising metals and the like, alkaline metals, or transition metals. Examples include sodium (Na⁺), potassium (K⁺), lithium (Li⁺), and cesium (Cs⁺), but the cations are not so limited. The cations may also comprise complex compounds such as ammonium (NH₄⁺), tetrabutylammonium (TBA⁺), or tetraethylammonium (TEA). Furthermore, a mix of cations may be used, which may be advantageous in achieving the desired properties such as solubility, pH, etc.

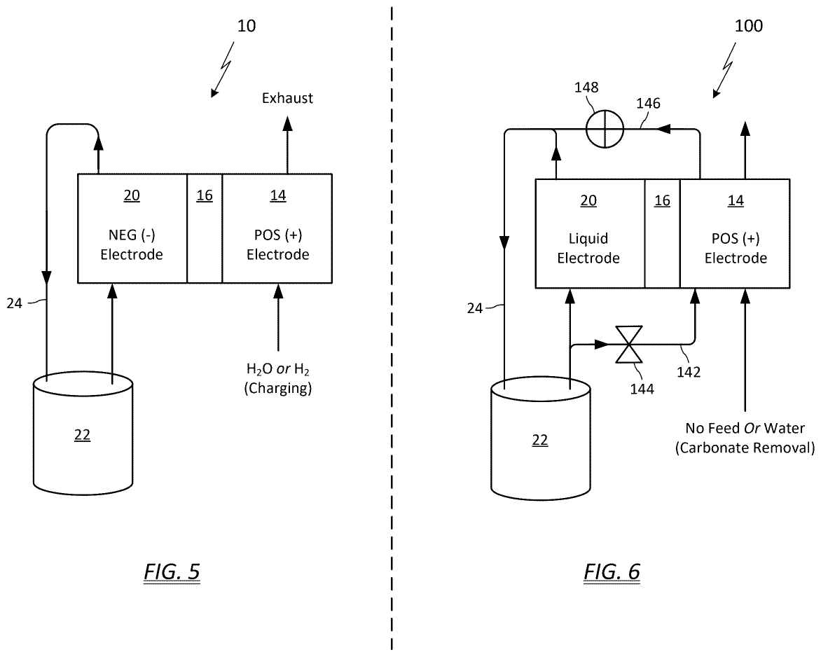

Turning to FIG. 4, shown is a typical fuel cell 11 which, in general, comprises the first (negative) electrode 12 and the second (positive) electrode 14 separated by a separator or membrane 16. The negative electrode 12 may include a negative catalyst layer 30ₙ and the positive electrode 14 may include a positive catalyst layer 30ₚ formed on respective sides of the generally planar separator 16. This assembly is typically referred to as a membrane electrode assembly (MEA) 32.

During discharging, reactants (e.g., liquid 20 and air) are directed to the MEA 32 by a flow field plate 34 that typically includes reactant flow channels (indicated by dashed lines). Flow field plate 34 is shown as a bipolar plate, which includes reactant flow channels for both the fuel and oxidant. The bipolar plate may also include interior flow channels for coolant (not depicted in FIG. 4). The reactants pass from the channels through a diffusion layer, either 36ₙ, or 36ₚ, abutting the flow field plate 34. The negative electrode diffusion layer 36ₙ may comprise a liquid diffusion layer (LDL), and the positive diffusion layer 36ₚ may include a gas diffusion layer (GDL) and a microporous layer (MPL) 38ₚ that is positioned between the GDL and the respective catalyst layer 30ₚ. Although not illustrated, the microporous layer 38ₚ may also include a catalyst layer abutting the catalyst layer 30ₚ. During charging, the reactants are liquid 20 and either hydrogen or water, which is fed to the same flow channels used for the air.

The catalyst layers 30ₙ, 30ₚ may include catalysts that promote the desired reactions. The catalysts may be supported on electrically-conductive supports, for example carbons or metal oxides. Furthermore, the catalysts may be more than one layer on either electrode to promote the desired charge and discharge reactions. The catalyst layers 30ₙ, 30ₚ may include an ionomer (i.e., a polymer with ionic groups) to enhance ionic conductivity in the layer, and may serve as a binder for the catalyst layer. Ionomer is desirable in the negative electrode since the liquid is a weak electrolyte with low ionic conductivity. Ionomer is needed in positive electrode since reactants are non-ionic.

The design and composition of the positive electrode 14 may be similar to cathodes used in fuel cells with polymer membranes, which include both proton-exchange membrane fuel cells (PEMFCs) and anion-exchange membrane fuel cells (AEMFCs). The gas-diffusion layer (GDL) 36ₚ may be hydrophobic (e.g., carbon paper or cloth with some PTFE added). This may be particularly desirable if the reactant is H₂ during charging. As noted, the GDL may consist of a micro-porous layer and macro-porous layer. The catalyst layer 30 may consist of two distinct layers with catalysts that promote the two desired reactions (charge and discharge). Alternatively, these multiple catalysts may be mixed in a single layer.

For a cell designed to operate under slightly acidic conditions with protons as the desired charge carriers, the catalysts may comprise Pt or other platinum-group metals (PGMs) or alloys. The ionomer will be a cation-exchange material, such as PFSA or other materials used in PEMFCs. It may be desirable to make the pH of this electrode moderate (e.g., between ~5 and 7), which can be enabled by using ionomers comprised of weak acidic ion-exchange resins, that will keep water phase in this electrode near-neutral.

For a cell designed to operate under slightly alkaline conditions with hydroxyls as the desired charge carriers, the catalysts may comprise a wide variety of materials, such as those used on the cathodes of AEMFCs. For example, Ni₃S₂ and Bi/C. The ionomer may be a anion-exchange material, such the material used for membranes in AEMFCs. It may be desirable to make the pH of this electrode moderate (e.g., between ~7 to 10), which can be enabled by using ionomers comprised of weak basic anion (WBA) ion-exchange resins, that will keep water phase in this electrode near-neutral.

The design and composition of the diffusion layer 36ₙ in the negative electrode 12 may be similar to those used in redox flow batteries (RFBs). This layer is hydrophilic on the negative side (e.g., carbon paper or cloth that has been pre-oxidized). Unlike most RFB electrodes, there may also be a catalyst layer included to help promote the desired redox reaction on this electrode. The catalyst layer may comprise two distinct layers with catalysts that promote the two desired reactions (charge and discharge) or mixed catalysts in one layer.

For a cell designed to operate under slightly acidic conditions with protons as the desired charge carriers, the catalysts 30ₙ may be supported on carbon and include Pd or alloys of Pd, other PGMs, Bi (e.g., Bi/C), Sn, or metal-organic catalysts and enzymes, such as a set of enzymes known as formate dehydrogenases (e.g., Pt(depe)). The ionomer will be a cation-exchange material; however, it may be desirable to make the pH of this electrode moderate (e.g., ~5-7), which can be enabled by using ionomers comprised of weak acid ion-exchange resins, that will keep this electrode near-neutral.

For a cell designed to operate under slightly alkaline conditions with hydroxyls as the desired charge carriers, the catalysts may be the same as those noted above, or of a broader range of materials enabled by this non-acidic conditions (i.e., not PGMs). The ionomer may be a anion-exchange material, such as the material used for membranes in AEMFCs. It may be desirable to make the pH of this electrode moderate (e.g., ~7-10), which can be enabled by using ionomers comprised of WBA ion-exchange resins, that will keep the liquid phase in this electrode near-neutral.

The composition of the electrolyte separator 16 is preferably electrically non-conductive, and designed to enable transport of the desired ionic charge carriers, but prevent transport of other species (i.e., is selective). A typical trade-off with separator material selection is conductivity versus selectivity. Some crossover is likely to occur with high-conductivity membranes, since properties that promote higher transport rates of desired charge carriers also tends to increase transport of other species. Therefore, a separator with perfect selectivity for the desired charge carriers will typically result in larger ohmic losses across the separator, which is undesirable.

Bearing this in mind, in one example a good choice for the separator 16 is an ion-exchange membrane. The liquid solution is not very ionically conductive (i.e., it is a weak electrolyte). The electrolyte membrane is sufficient for ion transport over very short distances (e.g., in electrodes), but not in thicker layers like the separator. The ion-exchange membrane may be a composite, for example reinforced with other materials such as microporous PTFE, to enhance mechanical properties of these relatively thin layers.

Multiple ion-exchange membrane options may be available. One example is a cation-exchange membrane, in which protons, or hydronium cations (H₃O⁺), are the desired charge carriers (which have high mobility). One potential advantage is that, due to the fixed anions in a cation-exchange membrane, they may help mitigate crossover of formate and bicarbonate anions. Furthermore, the positive electrode is likely to be acidic (pH<7), and this may prevent carbonate salts from forming, a noted problem with anion-exchange membranes due to the presence of CO₂ in the air (~400 ppm). In this case, bicarbonates that crossover may also result in formation of carbonate salts that may precipitate out and block electrodes.

Another example is an anion-exchange membrane, in which hydroxyl anions (OH⁻) are the desired charge carrier. They have lower mobility than protons, but still acceptable. A key advantage is that this may enable a less expensive catalyst for oxygen-reduction reactions (i.e., non-platinum-group metals). An anion-exchange membrane may also improve the kinetics of the formate/bicarbonate reaction, and may mitigate the formation of carbonates if the pH is not too high (e.g., use ionomer in the electrode that is a weak base).

As noted above, the separator 16 may include multiple layers. At least one layer has very small pores to prevent transport of larger species. The layer is relatively thin to minimize ohmic losses. The separator 16 may further include at least one additional layer to provide mechanical support of a very thin layer. The layers are preferably ion-exchange membrane materials, but may be non-ion exchange membranes. In one example, the very thin and selective layer is graphene, which is shown to be selective for transport of protons but not V or Mg ions, which are smaller than formate or bicarbonate ions. Rather than graphene, the layer with very small pores may alternatively be a polymer, such as polybenzimidazole (PBI).

The separator 16 may also be a “bipolar membrane,” in which one layer is a cation-exchange membrane and the other layer is an anion-exchange membrane. In aqueous solutions, protons and hydroxyls are the majority ions and they travel in opposite directions with an electric field, so the net result in this separator is:

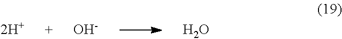

The two layers should be thin, to minimize ohmic losses. In one example, the configuration may be used in a cell that converts bicarbonate ions to formate ions on one electrode (i.e., charge reactions disclosed herein), while the opposite electrode undergoes an oxygen-evolution reaction.

The design and composition of the bipolar plate 34 may be conventional solid plates made from conventional materials such as carbon or metals. Solid plates are used in most fuel cells, since they provide a solid barrier between the reactants on the two electrodes and, because they are made from material with high electrical conductivity, have low ohmic losses. Many material options are available (e.g., graphite, metals, composites), especially in a near-neutral pH environment. In the application in which hydrogen is used for charging, more material options are available for solid plates, since the positive electrode does not need to be subjected to high electrochemical potentials, as is the case when water is split during charging. The entire bipolar plate may be made from graphite or a moldable graphite composite.

One drawback to solid plates is they typically require water management apparatus such as humidifiers in a conventional H₂/air cell. In another example, the bipolar plate 34 construction may include microporous plates, otherwise known as water transport plates (WTPs). WTPs are comprised of a porous solid with small, uniform and hydrophilic pores that provide a gas barrier by keeping the pores filled with liquid (e.g., water in conventional H₂/air cells). This design enables internal passive water management, well hydrated membranes, and system simplification. However, fewer material options are currently available, limited to graphite or composites.

In yet another example, the bipolar plate 34 construction may include a hybrid construction comprised of both a micro-porous layer and a solid layer; one electrode or both could utilize this configuration. Membrane dry-out is not thought to be a concern, but flooding of the gas electrode is a potential concern. Therefore, a porous plate layer may be utilized for gas channels. On the opposite side of the gas channels of the porous plate are water channels, and water may be circulated at lower pressure than the gas to provide water removal. The circulating water may also provide thermal management, such as circulating the water through an external heat exchanger or utilizing evaporative cooling. Furthermore, foreign anions or cations on the gas electrode may be removed by circulating the water through a demineralizer bed (i.e., an ion-exchange resin). In one implementation, if the reactant is water, such as on anode during charge, then water in the plate may be circulated at elevated pressure and gas removal may be via the open channels. On the liquid electrode, a microporous plate layer with hydrophobic pores may be used to circulate liquid in the channels while using the pores to help gases (e.g., H₂) exit the cell.

The flow field design in the bipolar plate 34 may have differing designs for the two electrodes. The positive electrode may be similar to those used in other fuel cells. That is, they may use straight gas channels, serpentine channels, or an interdigitated flow-field (IDFF) design, with the primary goal being to deliver gases uniformly to entire electrode area in all of the cells without excessive pressure drop. However, higher pressure drop designs, such as the serpentine design, may be preferable for water removal in the channels, especially if utilizing solid plates. The IDFF design is an excellent choice for a porous-plate design in which water removal is into the water stream circulated in the plate (not down the gas channels) and the gas is primarily single phase (i.e., fully humidified gas).

The negative electrode may be similar to those used in redox flow batteries, because active species dissolved in liquids have much lower transport rates than gaseous reactants (i.e., much smaller diffusion coefficients than gases). In one example, the design is “mixed flow,” in which liquid transport across the cell is a mixture of flow through channels (to minimize pressure drop) and also flow through the adjacent electrode layers (to minimize mass-transport losses). In one implementation, interdigitated flow-fields are utilized because they work exceptionally well with single-phase flow. Gas should be limited to that generated, e.g., H₂, and may be removed by ensuring that the reactant flow is from bottom to top of cell.

One important aspect of the disclosed invention is the impact of membrane crossover to the air-side electrode, which could poison the catalyst and degrade performance. Several different crossover scenarios exist, depending on whether there is an acidic or alkaline gas electrode. If the pH of the gas electrode is low (i.e., acidic), which can be enabled by using a highly acidic ionomer (e.g., a strong acid, such as perfluorosulfonic acid (PFSA)), the liquid phase on this gas electrode is primarily pure water, which may help keep these species in solution. They will stay dissolved unless they react.

If bicarbonate (or carbonate) anions cross over, most, or all, of the bicarbonates/carbonates will be converted to CO₂ due to the low pH environment. The CO₂ will then exit the cell as a gas in the exhaust stream, having no negative impact, other than the slow loss of reactant. If the pH of this electrode is not sufficiently low enough to convert all of the bicarbonate or carbonate species to CO₂, then they may also be oxidized to CO₂ with oxygen on the gas electrode, as described below in the case of formate species.

If formate anion crossover occurs, with oxygen on the gas electrode, the formate oxidizes, due to the high oxidizing potential, especially in the presence of most catalysts used to promote the oxygen-reduction reaction in an acidic environment (e.g., platinum-group metals). Some of the formate anions may also be converted to formic acid at low pH conditions. The reactions are the direct oxidation of formic acid and formates:

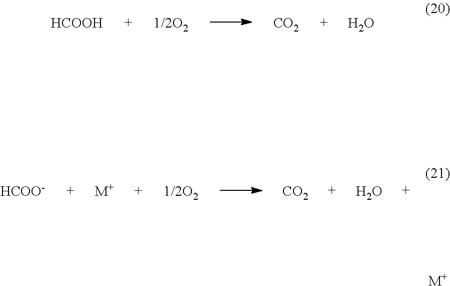

Formates and formic acid may also be electrochemically oxidized to CO₂:

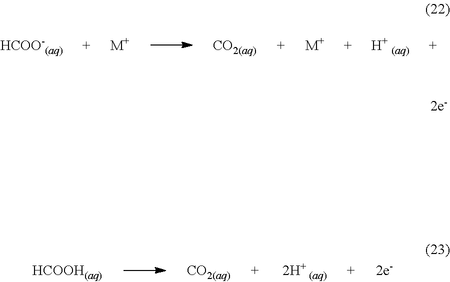

The CO₂ will then exit the cell as a gas in the exhaust stream, having no negative impact, other than the slow loss of reactant. In the case of formate anion oxidation, the resulting salt cations, M⁺, these foreign cations may be periodically removed, if needed, as described below.

If formate crosses over, with hydrogen on the gas electrode, then formate may still be oxidized, or it may accumulate until the next time the electrode is exposed to oxidizing conditions (e.g., air). Crossover is less likely during charging with an acidic electrode since the species are ‘going upstream’ versus proton flux.

If salt cations cross over, they will occupy anionic sites in the ionomer or ion-exchange membrane, since the free anions will be converted to CO₂ as explained above. These foreign cations may be periodically removed, if needed, as described below.

If the pH of the gas electrode is high (i.e., alkaline or basic), this may result in formation of insoluble carbonates from crossover (and from CO₂ in air) and therefore should be avoided. If formate crossover occurs with oxygen on gas electrode, the formate oxidizes to bicarbonates, due to the high oxidizing potential, especially in the presence of most catalysts used to promote the oxygen-reduction reaction in an acidic environment (e.g., platinum-group metals):

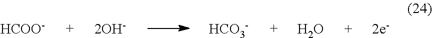

With hydrogen on the gas electrode, the formate may still be oxidized, or it may accumulate until next time electrode is exposed to oxidizing conditions (e.g., air). In either case, this will result in bicarbonate anions on the gas electrode, which is the same as bicarbonate crossover (described below).

If bicarbonate (or carbonate) anions cross over (or are generated due to formate crossover), most, or all, of these bicarbonates/carbonates will remain, or be converted to, bicarbonates due to the moderate pH environment. Bicarbonates have relatively high solubility and may stay in solution (if there are any free cations are present) or will occupy cationic sites in the ionomer or ion-exchange membrane. Carbonates will form, especially if the pH of the gas electrode is relatively high (i.e., uses a strong base ionomer). This is a similar problem as a conventional anion-exchange membrane fuel cell, in which carbonates form due to CO₂ in the air stream and high pH. These foreign anions can be periodically removed, if needed, as described next in several embodiments.

FIG. 5 depicts the rechargeable liquid fuel cell system 10 shown in FIG. 1. In this example, the gas electrode 14 is shown with the feed reactants used during charging. FIG. 6 depicts a simplified schematic of a modified rechargeable liquid fuel cell system 100 for removing carbonates from the gas electrode 14. The carbonates may accumulate as a result of crossover, or CO₂ in air stream.

During normal charging operations on fuel cell system 10 (FIG. 5), bicarbonate salts are converted back to formate salts with electrical energy input. In one method, discussed in relation to Eq. 8.2, water is split into oxygen and protons. Alternatively, instead of splitting water, hydrogen may be introduced to the positive electrode 14 to rehydrogenate the liquid electrolyte 20 with protons by oxidizing the hydrogen. See Eq. 10.1.

During the carbonate-removal process illustrated in FIG. 6, no feed gases or water are introduced to the positive electrode 14. Instead, conduit 142 supplies a small amount of liquid electrolyte 20 from the reservoir 22 to the positive electrode 14. In one example, a control valve 144 may regulate the liquid flow. The liquid electrolyte 20 promotes conversion of carbonates to bicarbonates if the pH of the electrolyte is lower than the pH of the ionomer and membrane, per the equilibrium reaction:

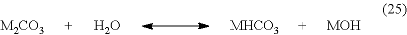

Equilibrium goes to the right at lower pH, resulting in release of a cation, M⁺. The reaction converts fixed cations to sites of OH⁻.

If free cations are present due to crossover, they may be returned to the liquid side 20 via conduit 146. If the free cations are impurities, they may be filtered out (if insoluble) by passing through filter 148. If the impurities are a soluble species, they may be simply added back to the liquid side 20, as it should be a small amount. The flow of liquid electrolyte 20 through positive electrode 14 may be stopped after a determined period, or after reaching a predetermined limit, such as the pH of the exit liquid.

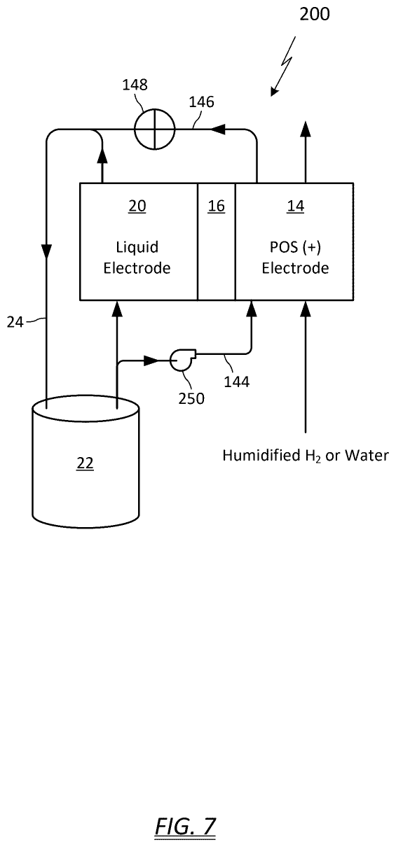

FIG. 7 illustrates a further modified rechargeable liquid fuel cell system 200 in which additional variations and embodiments to the recovery process are disclosed. For example, the recovery can be accomplished with no electrical current (i.e., during shutdown), or with a flowing current. The recovery will only need to be carried out periodically, but may be conducted while operating (e.g., charging from a very low state of charge SoC). The fluid fed to the positive electrodes 14 may be electrolyte only; electrolyte+water (i.e., dilute electrolyte), electrolyte+reactant (e.g., H₂ or O₂, if current is flowing); or electrolyte+water+reactant. The electrolyte feed to the positive electrode 14 may preferably be at a low state of charge (i.e., bicarbonate-rich). Alternatively, a very low state of charge electrolyte (~0 SoC) may be generated using a small “symmetric cell” (described below).

Additional system hardware to implement some embodiments of the recovery process include a small pump 250 to circulate electrolyte through the positive electrodes. Alternatively, the main electrolyte pump 26 (FIG. 1) may be utilized with a bypass loop (not shown). One or multiple sensors may be utilized to determine when the recovery process should be concluded. Examples include a pH detector on the liquid exiting the cell, and/or a means to measure impedance of cells or membranes to indirectly detect a change in carbonate versus hydroxyl anions in cells.

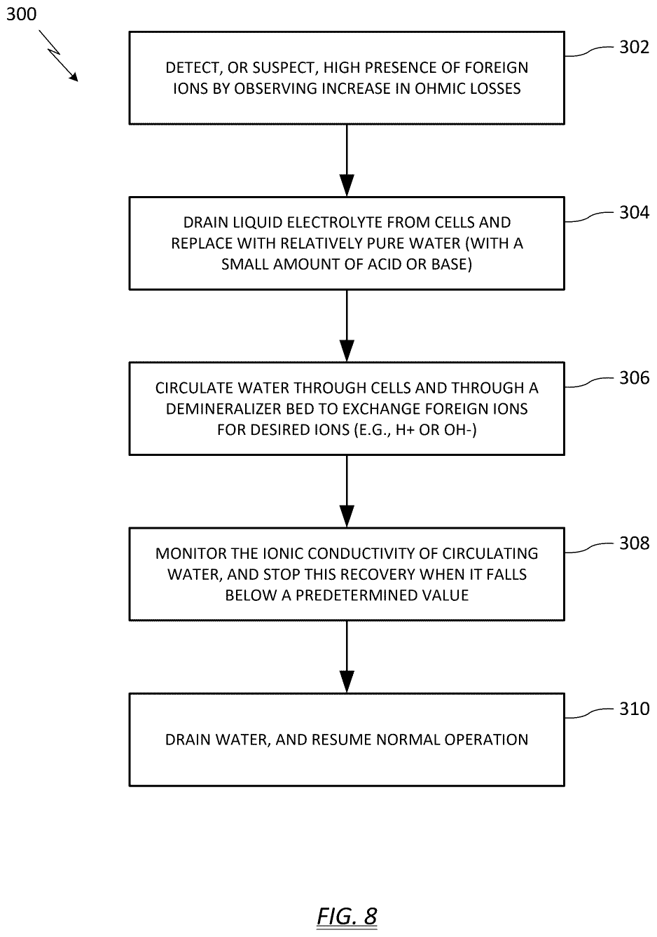

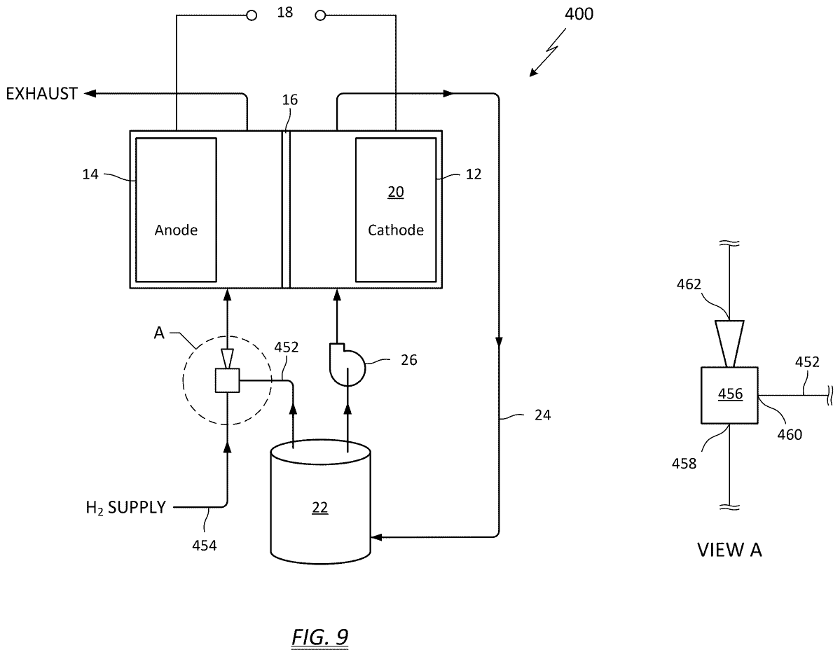

FIG. 8 is a block diagram flow chart illustrating an exemplary embodiment of a recovery method 300 for removing foreign ions in the ionomer or in the ion exchange membrane 16. Foreign ions may accumulate in the ionomer or in the ion exchange membrane due to membrane crossover (as disclosed above), or contaminates (e.g., impurities in the liquids or gases fed to cell). These foreign ions are not generally a concern unless they accumulate sufficiently to impact the performance, resulting in increased ohmic losses, which can be detected by a number of diagnostics, such as impedance, performance sensitivity to reactant flow rate (ohmic losses are not typically flow rate sensitive).

The method entails flowing water through the cells with a small amount of either an acid (for cation-exchange media) or a base (for anion-exchange media). This process can effectively remove the foreign ions, since the ionomer and ion-exchange membrane are essentially ion-exchange media and will reach equilibrium with the liquid phase.

Referring back to FIG. 8, the recovery method 300 includes a step 302 to detect a high presence of foreign ions by observing an increase in ohmic losses. As noted above, detection may also include measuring the pH of the liquid exiting the cell, and/or a means to measure impedance of cells or membranes.

At a step 304, the recovery procedure is initiated by draining the liquid electrolyte from cells and replacing it with relatively pure water having a small amount of acid or base.

The process continues at a step 306 by circulating water through the cells and then through a demineralizer bed (not shown in Figures) to exchange foreign ions for desired ions (e.g., H⁺ or OH⁻). At a step 308 the ionic conductivity of the circulating water is monitored, and the recovery may be stopped when the conductivity falls below a predetermined value.

Lastly, at a step 310 the recovery process is complete, and the water may be drained and normal operation may be resumed.

In another embodiment of the recovery process, the cells may be operated in a H₂-pump mode to ensure a high flux of water through the membrane. This may be accomplished by feeding the gas electrode with H₂ and applying a voltage potential to carry out a hydrogen-oxidation reaction (HOR) on the gas side and a hydrogen-evolution reaction (HER) on the liquid side. Additionally, a small amount of dilute water may be fed on gas side as well.

In another embodiment of the present invention, a rechargeable liquid fuel cell system permits a novel charging method that overcomes a problematic side reaction: the generation of H₂ on the cathode (refer to Eq. 7.3). The Faradaic Efficiency during charging may be <100%, due to H₂ generation (hydrogen-evolution reaction), which is an undesired side reaction on the liquid electrode 12 (cathode) during charging. In this embodiment, the method charges using bicarbonate salt or bicarbonate and formate salt electrolyte solution, and a gaseous reductant such as hydrogen. The method discharges using a formate salt or formate and bicarbonate salt electrolyte solution, and a gaseous oxidant such as oxygen or air.

The solution to the problem of accumulated hydrogen being entrained in the liquid electrolyte 20 involves transferring the hydrogen over to the gas electrode 14. This can be readily carried out if hydrogen is already being fed to the gas electrode 14 during charging (Eq. 10.1 and 10.2).

Referring now to FIG. 9, shown is a rechargeable liquid fuel cell system 400 for mitigating the H₂ generated on the cathode 20. In one embodiment, a gas vent 452 may be tapped from the cathode electrode 12, the recirculation loop 24, or the storage vessel 22, and fed to the anode electrode 14. In one example, a vent conduit 452 from the reservoir 22 tees into the hydrogen supply conduit 454. The dissolved hydrogen gas generated on the cathode will readily separate out of the liquid electrolyte stored in the vessel 22 as a gas when the solubility of hydrogen gas is exceeded.

The rechargeable liquid fuel cell system 400 may further include an ejector 456, such as a venturi pump or injector nozzle. In the illustrated embodiment, high pressure hydrogen from supply line 454 is supplied to the primary inlet 458 of the ejector, and the hydrogen vent 452 is connected to the ejector secondary inlet 460. The ejector outlet 462 connects to the inlet of the gas electrode 14. In operation, the ejector utilizes the high pressure hydrogen to create a low pressure region that suctions the hydrogen gas from the vent conduit 452 and mixes it into the H₂ supply stream.

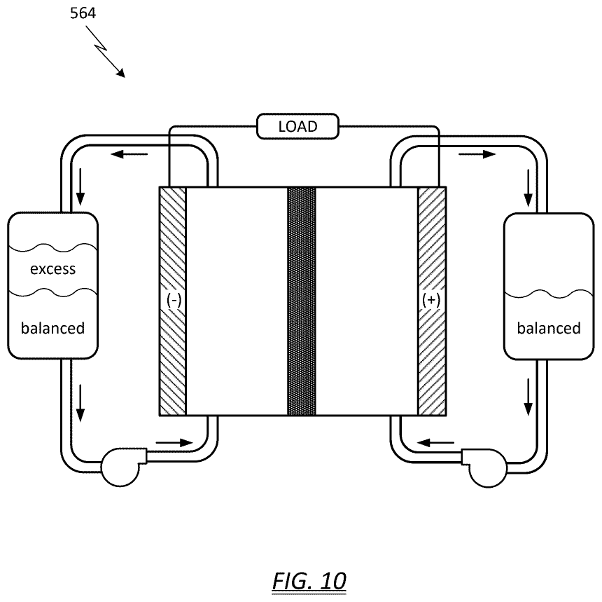

FIG. 10 illustrates a simplified symmetric cell 564 which may be used in another embodiment of the invention. In a symmetric cell, both sides of the separator cell have the same liquid electrolyte, instead of having dissimilar reactants. In this manner, one side is charging while the other side is discharging.

The one side being charged:

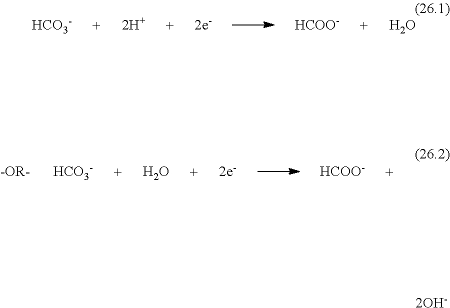

The other side being discharged:

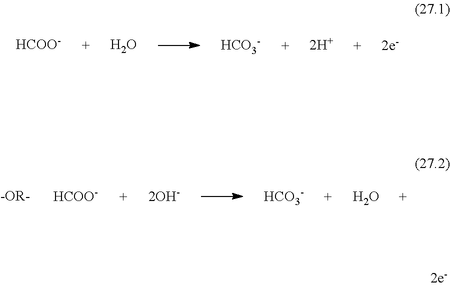

A voltage is applied to generate current in the cell. Typically this is done during the charging process, when energy is less valuable. The open circuit voltage is approximately zero if the composition of the electrolytes on both sides are similar. The net change in electrolyte is zero; that is, it would return to the same state if the two sides were mixed. The net reaction of the two half reactions is zero, however the charged side is enriched in formates and the discharged side is enriched in bicarbonates.

The symmetric cell can have a separate reservoir (or vessel) for only one side, or for both sides. A small reservoir may be filled with highly charged electrolyte (i.e., depleted in bicarbonates), which can be used to dissolve bicarbonates. Alternatively, a small reservoir may contain very low-SoC electrolyte (i.e., ~0 SoC; depleted in formates) to dissolve carbonates.

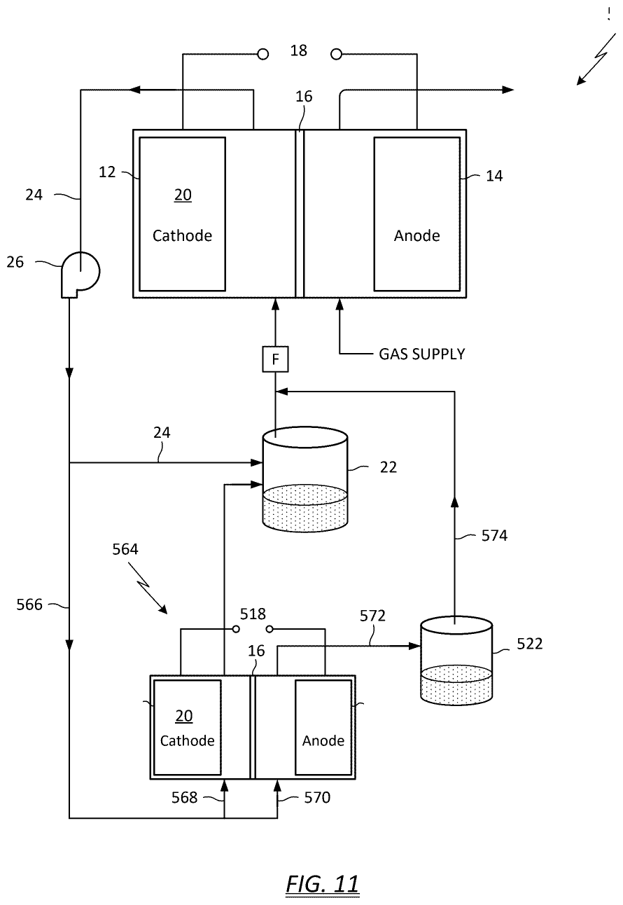

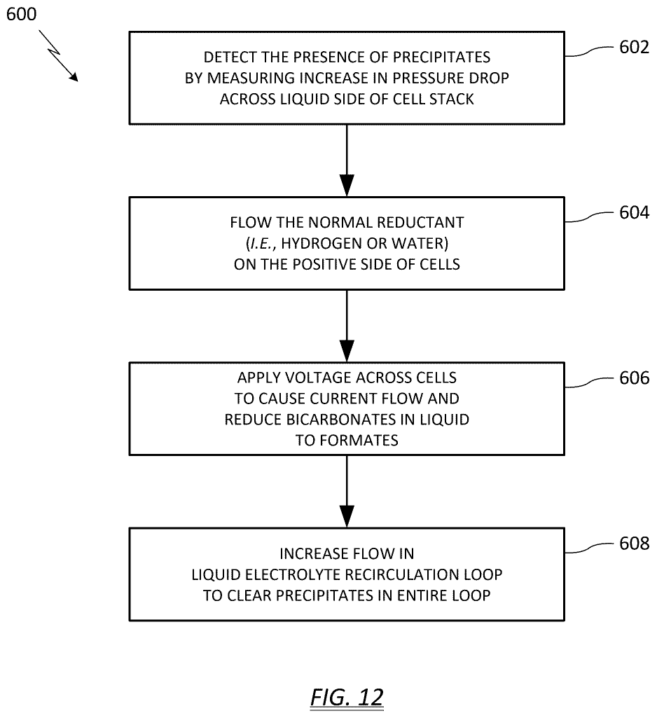

FIG. 11 illustrates the symmetric cell 564 used in another embodiment of the rechargeable liquid fuel cell system 500, to remove bicarbonates or carbonate precipitation in the system. The process preferentially generates and stores formate-rich solution using the symmetric cell described with reference to FIG. 10. The formate-rich solution is dilute with respect to bicarbonates and carbonates and, therefore, has the ability to readily dissolve these species. This is preferentially generated during charging, since electrical energy is less valuable at this time than during discharge. Note that no additional pump is required to circulate through the symmetric cell. Although not shown, a valve may be used to restrict flow to the symmetric cell when the cell is not needed.

Electrolyte is supplied to the symmetric cell 564 by an extension 566 of the recirculation loop, and both sides 568, 570 of the cell receive the same electrolyte. The formate-rich solution discharges via conduit 572 to a holding vessel 522, and is returned to the system via a flush recirculation loop 574. The vessel 522 may be sized according to its purpose. It may be the same volume as the entire recirculation loop (including the liquid volume in cell stack), if one wishes to fill the loop at shutdown to prevent precipitate. However, the volume of the vessel 522 may be less, if it is simply used to flush the recirculation loop.

Analogously, a bicarbonate-rich solution may also be used to help remove carbonates from positive side of cells. The symmetric cell 564 provides a method of independently making a formate-rich or bicarbonate-rich solution, storing it in a tank, and flushing the system whenever needed. Because it is independent of the operation of the whole system, a solution that has a certain composition can be made that would be useful for some future recovery.

FIG. 12 is a block diagram flow chart illustrating an exemplary embodiment of a method 600 for recovering from inadvertent precipitation on the liquid electrode 12. If the precipitation is due to bicarbonates, they can be rapidly removed by converting the bicarbonate solids to formates by charging (and formates have much higher solubilities). The method begins by detecting the presence of precipitates 602. In one example, detection may be by measuring an increase in the pressure drop across the liquid side of cell stack. The method next includes a step 604 of flowing the normal reductant, such as hydrogen or water, on the positive side of cells. At step 606, a voltage is applied across the cells to cause current to flow and reduce the bicarbonates in liquid to formates. Lastly, at a step 608 the liquid electrolyte flow is increased in the recirculation loop to clear precipitates in entire loop.

If the flow on liquid side is restricted, or even zero, the liquid in the cells may be charged by flowing normal charging reactant on the positive electrode (i.e., hydrogen or water) and charging. The flow on the liquid (negative) electrode 12 may gradually return to normal as the precipitates are removed in the electrodes.

The disclosed rechargeable fuel cell device includes a negative electrode that is supplied a rechargeable liquid during both charge and discharge. The rechargeable liquid is an aqueous solution with formate and bicarbonate anions as the active material. The cations can be a single species, or a mixture, and are preferably relatively large to enhance reaction kinetics, enhance the solubility of the bicarbonates, and mitigate membrane crossover. The cations may be selected from a group comprising metals and the like, alkaline metals, or transition metals. Examples include Na⁺, K⁺, Li⁺, and Cs⁺, NH₄⁺, TBA⁺, or TEA⁺. The rechargeable liquid operates at a moderate pH range; ideally from ~5 to 10, and preferably 6 to 9.

The system is designed to be charged with hydrogen on the positive electrode; however, the system is also designed to be charged with water on the positive electrode. The flow-fields and electrodes are designed to maximize the cell performance, and the separator is designed to minimize crossover of the active species, while also promoting the transport of the desired charge carriers (e.g., protons and/or hydroxyl ions). The system may optionally include a relatively small “symmetric cell” for the rechargeable liquid, which is used to generate liquids that are advantageous for recovery strategies. The system may optionally be designed to operate with two-phase solutions (solids and liquids) on the liquid side.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A rechargeable liquid fuel cell, comprising:
a negative liquid electrode comprising an electrochemically-reversible liquid fuel, the fuel comprising a formate salt and a bicarbonate salt;
a positive gas electrode comprising an oxygen-containing gas;
an electrolyte separator disposed between the negative liquid electrode and the positive gas electrode, the electrolyte separator comprising a first side having a negative catalyst layer formulated to promote, during fuel cell discharge, the electrochemical oxidation of formate ions to bicarbonate ions, and further comprising a second opposing side having a positive catalyst layer formulated to promote, during fuel cell discharge, an electrochemical oxygen reduction reaction (ORR); and
an electrical circuit connected to the positive and negative electrodes.

2. The rechargeable liquid fuel cell according to claim 1, wherein the negative liquid fuel comprises three species in equilibrium: dissolved CO_{2(aq)}, bicarbonate ions HCO₃⁻, and carbonate ions CO₃²⁻, and the pH of the liquid fuel is sufficient to favor the bicarbonate ions as a dominant species.

3. The rechargeable liquid fuel cell according to claim 2, wherein the negative liquid fuel operates, in bulk, in a pH range of about 5 to about 10.

4. The rechargeable liquid fuel cell according to claim 3, wherein the negative liquid fuel operates, in bulk, in a pH range of about 6 to about 8.

5. The rechargeable liquid fuel cell according to claim 1, wherein, during recharging, electricity is applied to the electrical circuit to promote the electrochemical reduction of bicarbonate ions to formate ions on the negative electrode and hydrogen gas is supplied to the positive gas electrode in place of the oxygen-containing gas, and the positive catalyst layer is further formulated to promote an electrochemical hydrogen-oxidation reaction (HOR).

6. The rechargeable liquid fuel cell according to claim 1, wherein the positive gas electrode is a reversible electrode, and during recharging electricity is applied to the electrical circuit to promote the electrochemical reduction of bicarbonate ions to formate ions on the negative electrode and water is supplied to the positive electrode in place of the oxygen-containing gas, and the positive catalyst layer is further formulated to promote an electrochemical oxygen-evolution reaction (OER).

7. The rechargeable liquid fuel cell according to claim 1, further comprising a recirculation loop connected to the inlet and outlet of the negative liquid electrode, and a vessel disposed within the loop to store the liquid fuel.

8. The rechargeable liquid fuel cell according to claim 7, wherein the liquid fuel stored in the vessel is a supersaturated two-phase solution comprising a solid and a liquid.

9. The rechargeable liquid fuel cell according to claim 1, wherein the primary cation in the negative liquid fuel is an alkali metal, a polyatomic ion, or combinations thereof.

10. The rechargeable liquid fuel cell according to claim 9, wherein the primary cation is selected from the group consisting of K⁺, Na⁺, Ce⁺, NH₄⁺, and combinations thereof.

11. The rechargeable liquid fuel cell according to claim 1, wherein the negative electrode includes a catalyst to promote the desired reactions.

12. The rechargeable liquid fuel cell according to claim 1, wherein the negative and positive electrodes further include an ionomer comprising a cation-exchange or anion-exchange material.

13. The rechargeable liquid fuel cell according to claim 12, wherein the ionomer comprises a weak acidic or weak basic ion-exchange resin configured to promote maintaining a near-neutral pH liquid phase in the negative and positive electrodes.

14. A method of discharging a rechargeable liquid fuel cell, comprising the steps of:
providing a negative liquid electrode, a positive gas electrode, an electrolyte separator disposed between the negative liquid electrode and the positive gas electrode, and an electrical circuit connected to the positive and negative electrodes;
flowing an oxygen-containing gas through the positive gas electrode to electrochemically reduce the oxygen;
flowing an electrochemically-reversible liquid fuel comprising a formate salt and a bicarbonate salt through the negative liquid electrode to electrochemically oxidize formate ions to bicarbonate ions; and
generating an electrical current in the electrical circuit.

15. The method according to claim 14, further comprising the steps of:
providing a negative liquid fuel comprised of three species in equilibrium: dissolved CO_{2(aq}), bicarbonate ions HCO₃⁻, and carbonate ions CO₃²⁻; and
maintaining a pH of the liquid fuel that is sufficient to favor the bicarbonate ions as a dominant species.

16. The method according to claim 15, wherein the pH, in bulk, is in a range of about 5 to about 10.

17. The method according to claim 16, wherein the pH, in bulk, is in a range of about 6 to about 8.

18. A method of recharging a rechargeable liquid fuel cell, comprising the steps of:
providing a negative liquid electrode, a positive gas electrode, an electrolyte separator disposed between the negative liquid electrode and the positive gas electrode, and an electrical circuit connected to the positive and negative electrodes;
applying an electrical current to the electrical circuit;
flowing a hydrogen-containing gas through the positive gas electrode to promote an electrochemical hydrogen-oxidation reaction (HOR); and
flowing an electrochemically-reversible liquid fuel comprising a formate salt and a bicarbonate salt through the negative liquid electrode to electrochemically reduce bicarbonate ions to formate ions.

19. A method of recharging a rechargeable liquid fuel cell, comprising the steps of:
providing a negative liquid electrode, a reversible positive gas electrode, an electrolyte separator disposed between the negative liquid electrode and the reversible positive gas electrode, and an electrical circuit connected to the positive and negative electrodes;
applying an electrical current to the electrical circuit;
flowing water through the reversible positive gas electrode to promote an electrochemical oxygen-evolution reaction (OER); and
flowing an electrochemically-reversible liquid fuel comprising a formate salt and a bicarbonate salt through the negative liquid electrode to electrochemically reduce bicarbonate ions to formate ions.

20. A method of removing foreign ions from an ionomer in cells of a rechargeable liquid fuel cell, comprising the steps of:
detecting a high presence of foreign ions;
draining any liquid electrolyte from the fuel cell and replacing it with water having an effective amount of acid or base to promote ion exchange;
circulating the water through the cells to exchange foreign ions for desired ions;
measuring an ionic conductivity of the circulating water;
ceasing circulation when the ionic conductivity decreases below a predetermined value; and
draining the water and resuming normal operation of the fuel cell.

21. The method according to claim 20, wherein the step of detecting the high presence of foreign ions comprises one of: measuring an increase in ohmic losses, measuring the pH of liquid exiting one or more cells, and measuring impedance of cells or membranes.

22. The method according to claim 20, further comprising the step of passing the circulating water through a demineralizer bed.

23. A method of removing undesirable precipitates on a liquid electrode in one or more cells of a rechargeable liquid fuel cell, comprising the steps of:
detecting a presence of unwanted precipitates;
flowing a normal reductant on the positive side of the one or more cells;
applying a voltage across the one or more cells to cause current flow and the electrochemical reduction of bicarbonates to formates in the liquid electrode; and
increasing a flow of liquid electrolyte to dislodge the unwanted precipitates.

24. The method according to claim 23, wherein the step of detecting the presence of precipitates comprises measuring an adverse increase in a pressure drop across the liquid side of the fuel cell.

25. The method according to claim 23, wherein the step of increasing the flow of liquid electrolyte comprises flowing the liquid electrolyte in a recirculation loop.
